(19) United States
(12) Patent Application Publication
(10) Pub. No.: US 2005/0127105 A1
(43) Pub. Date: Jun. 16, 2005

(54) Method and apparatus to supply a viscous liquid

(76) Inventor: George W. Kay, Sharon, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/732,050

(22) Filed: Dec. 10, 2003

(51) Int. Cl. G01F 11/06

(52) U.S. Cl. 222/211; 222/321.7

(57) ABSTRACT

A viscous liquid dispenser, comprising a pump mechanism; a supply reservoir; and an extension hose having an adapter end adapted to connect to the pump mechanism and having an uptake end disposed within the supply bottle, to deliver the liquid from the supply reservoir to the intake tube, the supply reservoir otherwise unattached to the pump mechanism. A viscous liquid supply system for delivering liquid to a pump mechanism, comprising a supply reservoir adapted to hold a supply of liquid; and an extension hose having an adapter end adapted to connect to the pump mechanism, the supply reservoir remaining unattached to the pump mechanism while in use, and the extension hose having an uptake end disposed in contact with the supply of liquid. A package for holding a quantity of a viscous liquid, comprising a supply reservoir holding in the supply reservoir a portion of the quantity of liquid; and an extension hose having an adapter end adapted to connect to a pump mechanism remote from the supply reservoir, and having an uptake end disposed in contact with the portion of the quantity of liquid, the extension hose holding a remainder of the quantity of liquid outside the supply reservoir.

### BACKGROUND

This patent application concerns a method and apparatus for delivery of a liquid soap, detergent, or viscous foodstuff such as ketchup, mustard or syrup, to a dispenser which might be mounted in an inaccessible or inconvenient location. Liquid soap dispensers have become ubiquitous in medical facilities, kitchens, lavatories, and showers because of their sanitary virtues, convenience, and cost effectiveness. Similarly, food dispensers of a similar construction are used in institutional and fast food settings to improve sanitation and ease of access, and to lower labor costs. Generally, the user, by triggering a sensor or applying a force, causes a dose of liquid to be dispensed. The motive force creating the flow might be gravity, a gas pressure differential, a spring, and/or the action of the user on a pump mechanism. There are many designs of liquid dispensers.

One general category of dispenser uses gas pressure differentials, generated by a remote foot pedal or a gas cartridge, for example, to drive a dose of liquid soap from a container to the dispenser tip. In this design, a volume of gas under a pressure higher than a pressure at the dispenser tip is introduced to the container holding the liquid soap and displaces it into a conduit leading to the dispenser tip.

Another category is that in which the dispenser pump operates by directly lifting the liquid itself by drawing it from the container through at least one valve to a dispenser tip. Although many liquid soap dispensers of this type are self-contained, disposable, and easily replaced, others are permanently mounted devices which frequently are incorporated as fixtures onto a kitchen or lavatory counter tops, for example. A liquid soap dispenser of this type is placed in a location which might be considered best by its designer on the basis of conformity with kitchen or bath conventions, ease of use by the consumer of the soap, esthetic and design considerations, ease of manufacturing and others. One or more of these considerations must be compromised to satisfy some of the others.

Another type of liquid dispenser, often used for milk, for example, uses a pinch valve to restrain the fluid, which is stored above, from flowing through a flexible tube to the open end which serves as the dispenser tip. In this arrangement, gravity is the motive force for the flow, and the valve is released by the user whenever flow is desired. The liquid is typically contained in a collapsible container including a flexible tube whose lumen is continuous with said container and is hermetically sealed according to food service standards. When the contents of the dispenser are ready to use, the sealed tip of the tube is removed, opening an access to the lumen.

As shown in FIG. 1, one type of dispenser under consideration, conventionally used for soap, is activated by the hand pressure. The typical mechanism 100 consists of a reservoir 101 of liquid, an elastic element 102, and two valves 103, 104 with necessary conduits. The force F applied by the user pressurizes the reservoir and causes the following events to occur: the inflow valve 104 closes; the outflow valve 103 opens; a dose of liquid is expelled toward the tip 105 of the dispenser; and the elastic element is deformed. When the force F previously applied by the user is released the following occurs: the elastic element 102 rebounds thus depressurizing the reservoir 101; the two valves 103, 104 reverse their states under the influence of the changed pressure vectors; the liquid, driven by the atmospheric pressure, fills the reservoir 101 from a supply conduit 106 which is fed from a soap container 107. The structure is sealed hermetically from the tip 108 of the supply conduit 106 to the tip 105 of the dispenser 100. The liquid container 107 is usually open to the atmosphere to allow for air entry, however, some dispenser containers are closed and collapsible to allow for exertion of pressure by the atmosphere directly from the wall. Ambient atmospheric pressure drives the viscous liquid through the conduits to the reservoir when the reservoir is depressurized. At the end of the cycle the reservoir and the elastic element are both restored to their initial conditions.

As illustrated, the reservoir 101 can be a cylinder equipped with a movable piston 109, in the illustration simply a slide-fit tube of smaller diameter than reservoir 101, driven by pressure applied by the user. The elastic element 102 is a spring which returns the piston 109 to its original position when the user-applied force is discontinued. As the piston 109 is retracted by the spring 102 it allows new soap to refill the reservoir. The valves 103, 104 can be simple check valves.

An alternate pump configuration may include a reservoir which is the lumen of a tube with elastic walls. The elastic walls of the reservoir can be collapsed by a force applied by the user. During the collapse the liquid is expelled toward the dispenser tip. In this case, the inflow valve may simply be an area of this tube which is pinched early in the cycle thus preventing a back-flow during the remainder of the cycle, or any other suitable valve. The outflow valve can be a simple check valve. When the user-applied force is discontinued, the tube returns to its original shape by elastic rebound allowing inflow of new liquid from the supply conduit.

The conventional dispenser pump mechanisms recharge the reservoir through a short conduit 106 immersed in the liquid held in an attached container 107 as explained above. The container 107 is conventionally a small bottle or ajar fixed to the pump mechanism, for example by screw threads 110, as shown. As the liquid is dispensed, the container 107 needs to be periodically refilled or replaced. Because of prevailing standards and limited space among the plumbing fixtures under the counter top, whether adjacent a sink or in a food dispensing stations:
1. The container 107 is small, often holding less than a pint, making frequent refills necessary;
2. The opening of the container 107 is narrow making for the refilling of its contents with a viscous liquid difficult, if not time consuming and inconvenient; and
3. The location of the container is inconvenient for refilling, being located under the sink, an enclosed cabinet for example.

In some conventional soap pumps, refilling can be done through a narrow opening in the counter top after removal of the pump mechanism. In another common design, the container is retrieved by unscrewing it from its position immediately under the counter and behind the sink and then replaced after filling. In the first case, other structures such as the back splash, the plumbing fixtures, and the counter top itself interfere with convenient refilling from what usually is a large bottle. Pouring the viscous liquid through a narrow orifice adds to the inconvenience of the process and likely tends to limit the usefulness of the dispenser. In the second case, the location behind the sink, in the back, upper corner of the sink cabinet, which is typically filled with supplies and traversed by plumbing pipes, is enough to discourage a user from refilling the dispenser.

### SUMMARY OF INVENTION

According to an embodiment of one aspect of the invention, a viscous liquid dispenser, comprising a pump mechanism; a supply reservoir; and an extension hose having an adapter end adapted to connect to the pump mechanism and having an uptake end disposed within the supply bottle, to deliver the liquid from the supply reservoir to the intake tube, the supply reservoir otherwise unattached to the pump mechanism.

According to an embodiment of another aspect of the invention, a viscous liquid supply system for delivering liquid to a pump mechanism, comprising a supply reservoir adapted to hold a supply of liquid; and an extension hose having an adapter end adapted to connect to the pump mechanism, the supply reservoir remaining unattached to the pump mechanism while in use, and the extension hose having an uptake end disposed in contact with the supply of liquid.

According to an embodiment of yet another aspect of the invention, a package for holding a quantity of a viscous liquid, comprising a supply reservoir holding in the supply reservoir a portion of the quantity of liquid; and an extension hose having an adapter end adapted to connect to a pump mechanism remote from the supply reservoir, and having an uptake end disposed in contact with the portion of the quantity of liquid, the extension hose holding a remainder of the quantity of liquid outside the supply reservoir.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a side view of a conventional liquid hand soap pump and supply;

FIG. 2 is a side view of an embodiment of the invention;

FIG. 3 is a side view of the adapter of the embodiment of FIG. 2;

FIG. 4 is a side view of an alternative adapter;

FIG. 5 is a side view of another alternative adapter;

FIG. 6 is a side view of a container and cap useful in connection with aspects of invention;

FIG. 7 is a detail of the container and cap of FIG. 6 as used to prime the system;

FIG. 8 is a detail of the container and cap of FIG. 6 with a sealing washer in place for shipping, storage, etc.;

FIG. 9 is a schematic cross-sectional view of an alternate pump mechanism suitable for use in connection with embodiments of some aspects of the invention;

FIG. 10 is a schematic cross-sectional view of yet another alternate pump mechanism suitable for use in connection with embodiments of some aspects of the invention; and

FIG. 11 is a schematic cross-sectional view of yet another alternate pump mechanism suitable for use in connection with embodiments of some aspects of the invention.

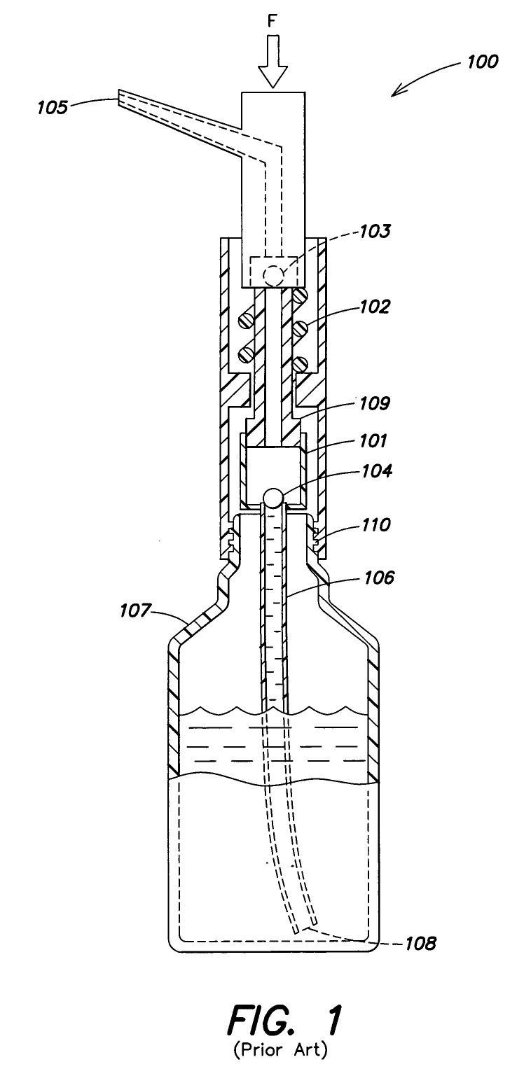

### DETAILED DESCRIPTION OF THE INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “compromising,” or “having,” “containing,” “involving”, and variations thereof herein, is meant to encompass the items listed thereafter and equivalents thereof as well as additional items.

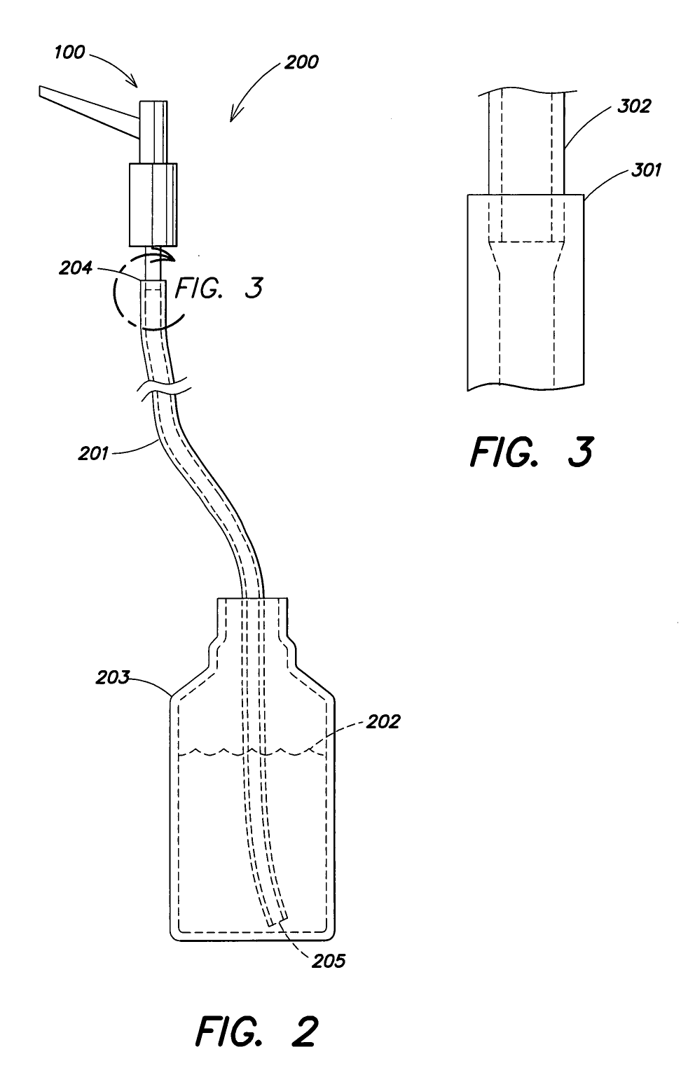

An embodiment of the invention is now described in connection with FIG. 2.

An exemplary apparatus 200 includes a length of flexible conduit 201, such as a plastic tube, which would allow the dispenser pump 100 to draw liquid 202 from a supply container 203 situated in a more convenient location, remote from the dispenser pump 100. The supply container 203 may be located in a position unattached to the dispenser pump 100 or its housing. That is, supply container 203 may be out of direct contact with the dispenser pump 100 nor in a specifically limited geometric configuration.

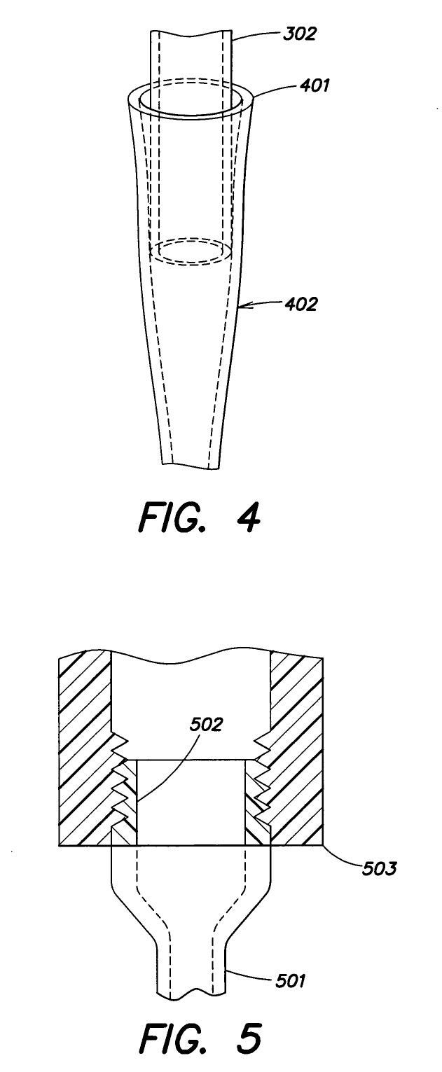

One end of the tube 204 is attached to the dispenser pump 100 establishing a hermetic seal, while the other end 205 is immersed in the liquid 202 to be dispensed, which is held in supply container 203. The end of the tube 204 is attached to the dispenser pump 100, preferably using a quick disconnect type of connection. An example of such attachment, shown FIG. 3 is one of a tube 301 having an inside diameter that just fits over the intake element 302 of the dispenser pump and yet holds it firmly enough as to be secure and sealed. As shown in FIG. 4, slight flare 401 to this end of the tube 402 aids in the process. This design would be particularly appropriate to after market applications. Tubes of Tygon™ (available from Saint-Gobain Performance Plastics Corp.) or other suitable materials, configured as shown in FIGS. 3 and 4 make reliable, quick disconnect connections. Alternatively, as shown in FIG. 5, the tube 501 could terminate in a threaded flange 502 corresponding to a threaded receptacle 503 provided in the pump head into which a threaded neck of a conventional small supply bottle would conventionally be screwed. In yet another alternative, not shown, the tube might be permanently attached to the dispenser housing by any suitable structure, during manufacture of the dispenser and packaged for retail ready to be threaded through an opening prepared in the counter top to receive the dispenser itself. The other end of the tube only needs to be small enough to pass through the mouth of the bottle holding the liquid soap. In order to accommodate a variety of sink and cabinet layouts, the tube (FIG. 2, 201; FIG. 3, 301; FIG., 402; and FIG. 5, 501) should preferably be long enough to reach the floor when in use.

The tube should be flexible enough to be threaded from the dispenser to the soap bottle and yet be able to resist collapse. The tube may be of any suitable material, for example a polymeric material, including those materials that are elastic, elastomeric, semi-rigid, articulated or the like, as required to provide the stated properties. As mentioned above, Tygon is one such material. The maximum length and minimum diameter of the tube depend on the viscosity of the liquid to be transported. The maximum vertical difference between the pump reservoir and the soap level in the liquid soap container is limited by the strength of the rebound of the elastic element of the pump, the strength of the outflow valve of the pump, and the partial pressure of water, or other volatile solvents in the liquid soap. The theoretical considerations relating to vapor pressures of typical soap products suggest differences of less than fifteen feet, which is well beyond the expected applications within a vanity or a kitchen cabinet. In a typical vanity or kitchen cabinet installation, the remotely located soap container could be in a range of from several inches away from the pump to several feet away from the pump. The skilled artisan can readily adapt this computation to other viscous liquids, including oils, food products, such as ketchup, mustard, syrup or the like, etc.

The valves used in hand pumps of the type for which embodiments described are useful do not seal well enough to raise a column of liquid soap in a tube that is full of air. The leaky valves work well only when immersed in a relatively viscous fluid, such as the liquid soap.

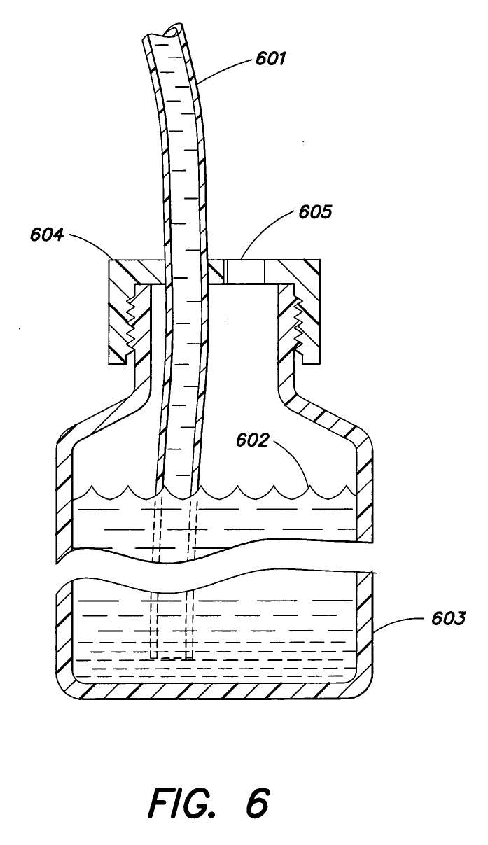

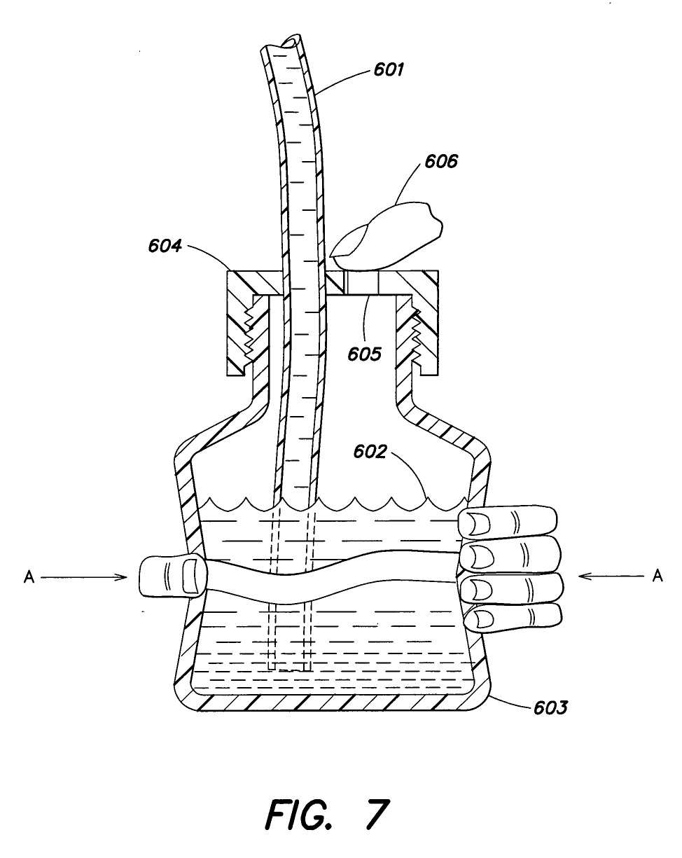

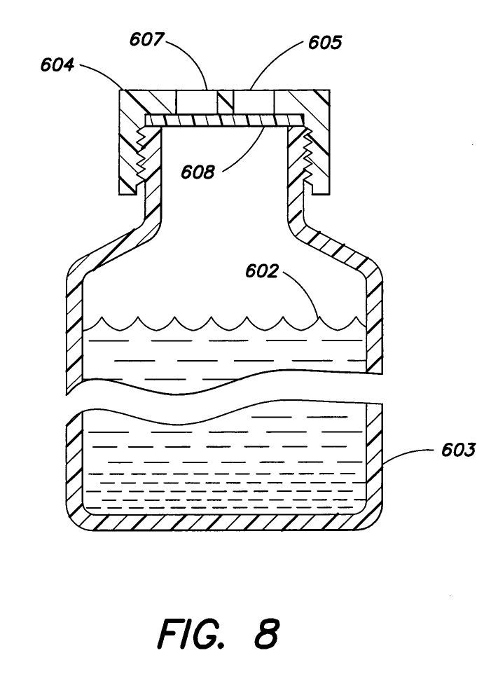

The following method, described in connection with FIGS. 6, 7 and 8, can be used to fill the tube 601 conveying the liquid 602 from the container 603 (e.g., bulk refill bottle) to the dispenser (not shown). The container 603 that holds the liquid 602 may be constructed of material that is easily deformed by hand when squeezed, A. The container 603 may be fitted with a cap 604 which during normal operations of the dispenser, i.e. dispensing of the liquid, allows both the passage of the liquid out of the container 603 and to the tube 601 leading to the dispenser, and the passage of ambient air into the container 603. The channel 605 through which the air might flow in is constructed in such way that it can be closed off by the operator 606 during the operation of filling of the tube 601. This channel 605 can, for example, be a simple opening in the cap 604 that can be closed off by finger pressure. With the tube 601 attached to the container 603 in the position in which it will draw the liquid from the container 603, the operator 606 can close off the air channel 605 and squeeze the bottle, A, generating enough pressure within to flow the liquid 602 contained therein to the other end of the tube 602. Depending on the construction of the dispenser, its pump, and its method of attachment to the tube 601, the latter is either already attached to the dispenser and will fill it with the liquid 602 can be attached at that point in time.

As an example of implementation of this method, the cap 604 has two equal round openings 605, 607, either of which will allow the tube 601 to pass through and yet form a hermetic seal. The tube 601 is pulled far enough through one opening 607 so that when the cap 604 is placed on the container 603 it reaches the bottom. The cap 604 with the two openings 605, 607 is fitted with a disposable washer 608 that prior to the unsealing of the container 603 provides its seal. The seal formed when the washer 608 is held in place by the cap 604 allowing the cap 604 to serve during the storage, shipping, and retailing of the liquid to be dispensed, and during its end use by the consumer, thus eliminating the need for separate part. The washer 608 could include one or more flaps or resealable holes to effect the selective seal described above without discarding the washer 608 when the container 603 is in use.

In some embodiments, the tube 601 can be provided pre-filed with liquid, for example for use in connection with aspects of the embodiment of FIG. 5.

Some further alternative embodiments of aspects of the invention are now described.

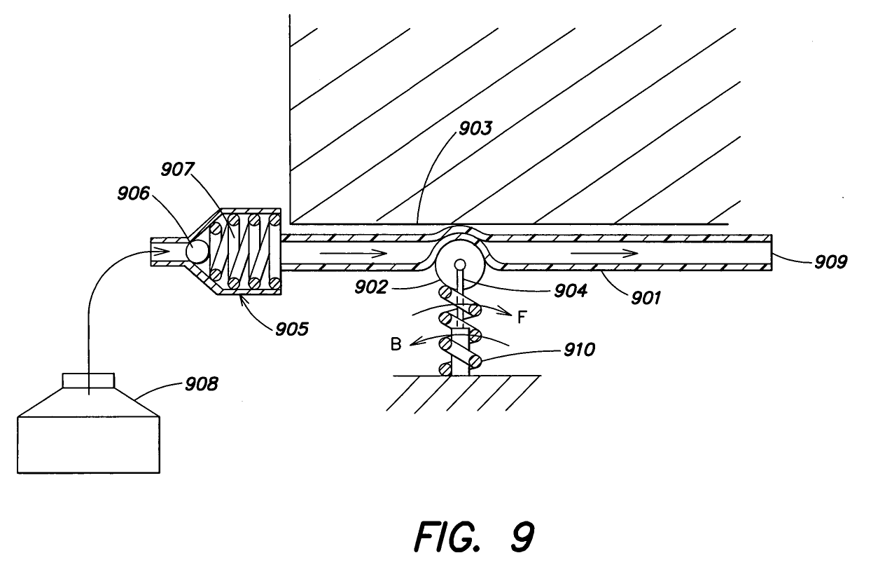

As shown in FIG. 9, other styles of pump are useful in connection with aspects of embodiments of the invention. In the illustrated embodiment, a long flexible conduit 901 is pinched between a roller 902 and a substantially stationary surface 903. Although a flat surface is shown, it need not be flat, provided the mechanism accommodates the contour of the surface 903. However, the surface 903 should be firm and continuous. Roller 902 is rotatably attached to an end of a pivoting compressor arm 904 which may swing forward, F, push fluid through tube 901. The arm can later swing back, B, to recover to a starting position. In order to prevent fluid from backing up through tube 901 when the arm 904 swings in direction B, a check valve 905 of any suitable design is provided. Check valve 905 can simply be an expanded portion of tube 901 in which a ball 906 seals tube 901, with the assistance of spring 907 while arm 904 swings in the recovery direction, B. When arm 904 swings forward, A, ball 906 and spring 907 are displaced by the pressure of fluid passing through tube 901. Fluid may be drawn from a container 908 disposed some distance away from a discharge end 909 of tube 901.

In order to accommodate a flat stationary surface 903 or a surface 903 of another arbitrary contour, roller 902 may be forced against tube 901 by a spring 910. Arm 904 should therefore be slidably elongatable as it moves through its arc. Any other suitable means for keeping roller 902 in contact with tube 901 and stationary surface 903, with sufficient pressure to fully pinch off tube 901 may be used.

In this embodiment, tube 901 and container 908 may be constructed from one or more pieces joined to comprise a single, integrated unit, sealed from the interior of container 908 to the discharge end 909 of tube 901. The discharge end 909 of the tank 901 may be initially sealed, and may be unsealed upon installation by removal of the sealed discharge end 909 of tube 901, thus opening the lumen to the outside world. This sealed construction is particularly advantageous for fluids which may be foodstuffs or other products for which high levels of sanitation or sterility are preferable. The container 908 and tube 901, thus formed as a single, integral unit may be sold, as such and installed in the pump by the end user, by simply slipping tube 901 between roller 902 and the stationary surface 903. Guiding features, channels and the like may be provided in practical embodiments, to assist in the process of inserting tube 901 between roller 902 and stationary surface 903. Filling the tube 901may be accomplished by compression of the container 908. In alternative arrangements, the tube 901 and container 908 can be separate parts, such as in the case of fluids supplied for intravenous administration. The tube and bag would be joined using a conventional needle and septum or other suitable means.

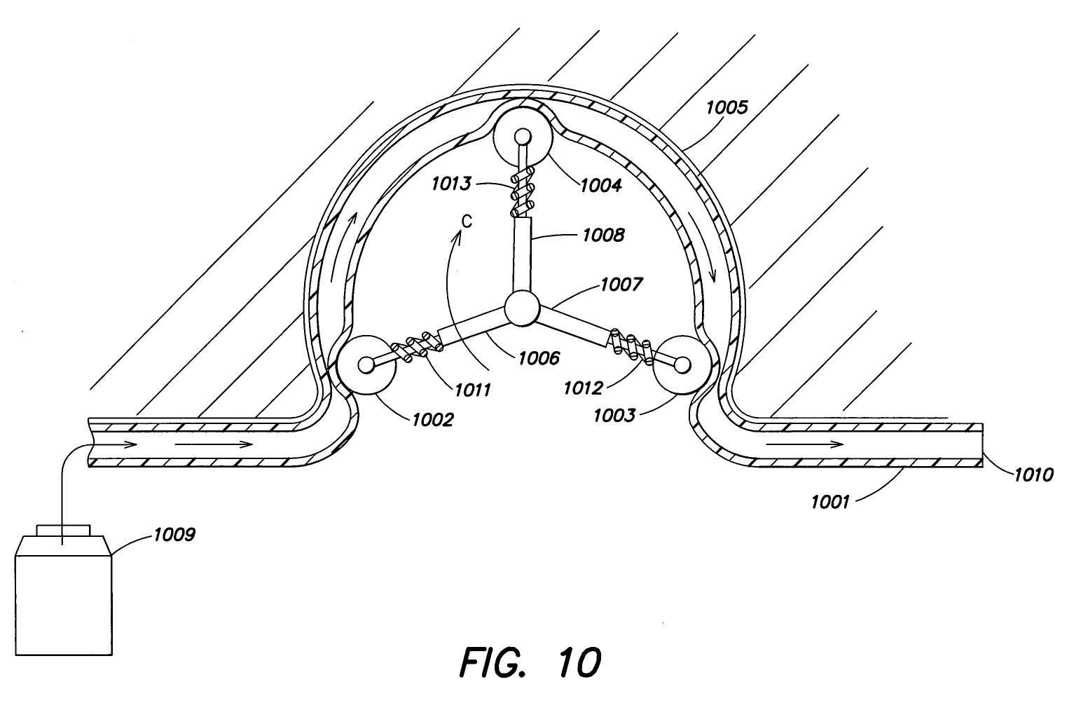

In another alternative embodiment, illustrated in FIG. 10, a simple, unobstructed tube 1001 is pinched between rollers 1002, 1003 and 1004, and concave stationary surface 1005. Rollers 1002, 1003 and 1004 are supported at the ends of compressor arms 1006, 1007 and 1008 rotating the structure including arms, 1006, 1007 and 1008 in direction C, for example by means of a crank (not shown), pumps fluid from container 1009 toward discharge end 1010 of tube 1001. As in the structure illustrated in FIG. 9, container 1009 can be made of one or more pieces, joined to be integral with and sealed to tube 1001. In order to accommodate variations in the shape of concave surface 1005, springs 1011, 1012 and 1013 may be provided to force rollers 1002, 1003 and 1004 against tube 1001. Concave stationary surface 1005 may be cylindrical, or may be of any other convenient contour that can be accommodated by the arms 1006, 1007 and 1008.

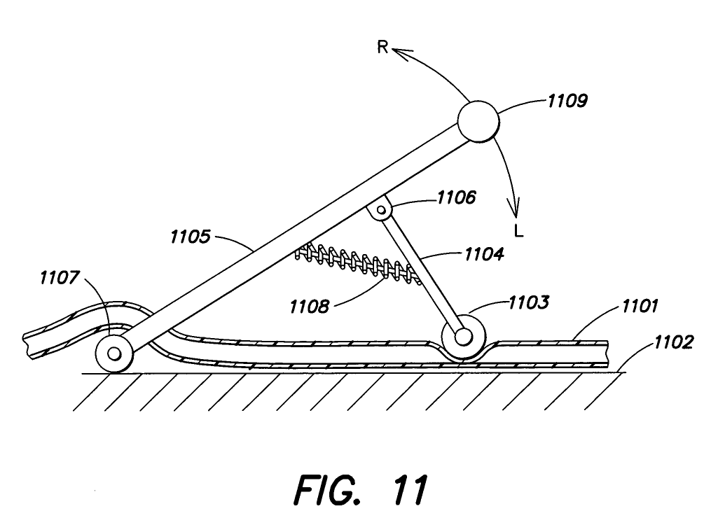

Yet another alternative embodiment, this being a variation on that shown in FIG. 9, is shown in FIG. 11. In this embodiment, a tube 1101 is threaded between a stationary surface 1102 and a pinch roller 1103. Pinch roller 1103 moves along tube 1101 in such a manner as to push fluid along the tube 1101 in one direction. Arm 1104 carries pinch roller 1103. Arm 1104 pivotably connects pinch roller 1103 to lever 1105 through hinge 1106. Lever 1105 pivotably connects to stationary surface 1102 through hinge 1107. Spring 1108 returns the arm 1104 to a starting position when lever 1105 is raised R, using handle 1109, and helps force pinch roller 1103 against tube 1101 when lever 1105 is lowered L, towards tube 1101. When a quantity of fluid is desired to be pumped through the tube 1101, lever 1105 is lowered in direction L, forcing arm 1104 and pinch roller 1103 towards surface 1102 and pinching off tube 1101 at the point of contact with pinch roller 1103. As lever 1105 continues motion in direction L, pinch roller 1103 moves the point of contact along tube 1101, forcing fluid in the pinched off section to move correspondingly along tube 1101.

In the preceding three exemplary embodiments, particularly if container (FIG. 9, 908; FIG. 10, 1009; FIG. 11, not shown) is sealed to or integral with tube (FIG. 9, 901; FIG. 10, 1001; FIG. 11, 1101), then the container (FIG. 9, 908; FIG. 10, 1009; FIG. 11, not shown) may be a flexible bag, such as an intravenous fluid bag or commercial milk dispenser bag, or the like. By using such containers, the choice of location for placement of the container is more flexible. The may be placed above or below the level of the dispenser tip because flow is not gravity induced, but rather results from the action of the pump mechanism. Such containers can be hung from suitably placed hooks or can be laid flat on a shelf, floor or other flat surface, without fear of siphoning because the pump mechanisms described fully seal the tube (FIG. 9, 901; FIG. 10, 1001; FIG. 11, 1101). The embodiments of FIGS. 9, 10 and 11 are further advantageous because the fluid moved by the pump never touches the pump mechanism, always being contained within the lumen of the tube. In any of these embodiments back flow may optionally be prevented by any suitable check valve, for example integrated into the tube, such as a ball valve, a double-reed valve, or a leaflet valve. The geometry and action of the arms can also prevent back flow, such as in the embodiment of FIG. 10.

A prototype application in a typical kitchen environment with the following characteristics has been performing well for over one year dispensing several gallons of soap:
1. The tube is composed of Tygon™ tubing with approximate wall thickness of one sixteenth of an inch and inside diameter of approximately three sixteenths of an inch:
2. The length of the tube is approximately four feet;
3. The vertical difference between the dispenser and the liquid level is approximately two feet;
4. Consumer grade, commercially available liquid soaps (for example, Softsoap™, available from Colgate-Palmolive Co.) have been used; and
5. A residential grade liquid soap dispenser supplied with a conventional kitchen faucet set (available from Delta Faucet Co.) has been used.

Embodiments of aspects of the invention employing long supply tubes provide for greater choice with regard to the most convenient placement of the liquid soap container. As opposed to the typical under-the counter, back-upper-corner location among the plumbing pipes behind the sink, the container can be kept near the front of the kitchen cabinet where it can be readily monitored and serviced.

Embodiments of aspects of the invention can also permit decreasing the frequency of refilling by facilitating the use of large container for example a one gallon standard refill bottle as compared to a standard one pint container, an eight-fold decrease in frequency of servicing the dispenser. Embodiments of aspects of the invention also reduce or eliminate the need for transferring a viscous liquid from a refill bottle to a smaller container that is a part of the fixture. A disposable refill bottle can itself be used as the container from which the soap is drawn.

Furthermore, some embodiments of the invention can completely eliminate the need for immediate proximity of the container holding the liquid to the dispenser pump. That in turn removes constraints on the design of the container holding the liquid soap. In fact the need for the small specialized container usually supplied with these fixtures is totally eliminated by embodiments of the invention. The manufacturer need only substitute a length of flexible tubing for the specialized bottle which is otherwise needed, resulting in net cost savings.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by the way of example only.

1. A viscous liquid dispenser, comprising:
a pump mechanism;
a supply reservoir; and
an extension hose having an adapter end adapted to connect to the pump mechanism and having an uptake end in contact with the liquid to be dispensed, to deliver the liquid from the supply reservoir to the intake tube, the supply reservoir otherwise unattached to the pump mechanism.

2. The dispenser of claim 1, wherein the adapter end further comprises:
a threaded end constructed and arranged to screw into the pump mechanism.

3. The dispenser of claim 1, wherein the extension hose further comprises:
a length of flexible tube having a lumen defined therein, and extending through the pump mechanism.

4. The dispenser of claim 1, wherein the adapter end further comprises:
a flared end constructed and arranged to hermetically seal to the pump head mechanism.

5. The dispenser of claim 4, the extension hose further comprising:
a flexible tube.

6. The dispenser of claim 5, the flexible tube further comprising:
a polymeric material.

7. The dispenser of claim 6, wherein the polymeric material is a copolymer.

8. The dispenser of claim 6, the plastic material further comprising:
Tygon™ material.

9. The dispenser of claim 5, the flexible tube further comprising:
an elastomeric material.

10. The dispenser of claim 1, wherein the supply reservoir has a flexible wall.

11. The dispenser of claim 10, wherein the supply reservoir is substantially devoid of air.

12. The dispenser of claim 10, wherein the supply reservoir collapses as liquid is removed therefrom.

13. The dispenser of claim 1, wherein the reservoir is located below the pump mechanism.

14. The dispenser of claim 1, wherein the reservoir is located above the pump mechanism.

15. The dispenser of claim 3, further comprising:
a compressor arm and a surface, between which the length of flexible tube extends, the pumping action resulting from motion of the compressor arm to compress the flexible tube so as to separate one portion of the lumen thereof from another portion of the lumen thereof.

16. The dispenser of claim 15, wherein the compressor arm reciprocates, further comprising:
a check valve preventing back flow.

17. The dispenser of claim 15, wherein the surface defines a cylindrical periphery and the compressor arm revolves around the periphery defined by the surface.

18. The dispenser of claim 15, wherein the compressor arm further comprises:
a pinch roller configured to compress and roll along the flexible tube as the compressor arm moves.

19. The dispenser of claim 16,wherein the check valve is integrated with the extension hose.

20. The dispenser of claim 19, the check valve being of a double-reed type.

21. The dispenser of claim 19, the check valve being of a ball valve type.

22. A viscous liquid supply system for delivering liquid to a pump mechanism, comprising:
a supply reservoir adapted to hold a supply of liquid; and
an extension hose having an adapter end adapted to connect to the pump mechanism, the supply reservoir remaining unattached to the pump mechanism while in use, and the extension hose having an uptake end disposed in contact with the supply of liquid.

23. The system of claim 22, wherein the extension hose further comprises:
a threaded end constructed and arranged to screw into the pump mechanism.

24. The system of claim 22, wherein the extension hose further comprises:
a length of flexible tube having a lumen defined therein, and extending through the pump mechanism.

25. The system of claim 22, wherein the extension hose further comprises:
a flared end constructed and arranged to hermetically seal to the pump mechanism.

26. The system of claim 25, the extension hose further comprising:
a flexible tube.

27. The system of claim 26, the flexible tube further comprising:
a polymeric material.

28. The system of claim 27, wherein the polymeric material is a copolymer.

29. The system of claim 27, the plastic material further comprising:
Tygon™ material.

30. The system of claim 26, the flexible tube further comprising:
an elastomeric material.

31. The system of claim 22, wherein the supply reservoir has a flexible wall.

32. The system of claim 31, wherein the supply reservoir is substantially devoid of air.

33. The system of claim 31, wherein the supply reservoir collapses as liquid is removed therefrom.

34. The system of claim 22, wherein the extension hose further comprises:
a threaded end constructed and arranged to screw into the pump mechanism.

35. The system of claim 22, wherein the extension hose further comprises:
a flared end constructed and arranged to hermetically seal to the pump mechanism.

36. The system of claim 22, wherein the reservoir is located below the pump mechanism.

37. The system of claim 22, wherein the reservoir is located above the pump mechanism.

38. The system of claim 24, further comprising:
a pinch roller and a surface, between which the length of flexible tube extends, the pumping action resulting from motion of the pinch roller to compress the flexible tube so as to separate one portion of the lumen thereof from another portion of the lumen thereof.

39. The system of claim 38, wherein the pinch roller reciprocates, further comprising:
a check valve preventing back flow.

40. The system of claim 38, wherein the surface defines a cylindrical periphery and the pinch roller revolves around the periphery defined by the surface.

41. The system of claim 39, wherein the check valve is integrated with the extension hose.

42. The system of claim 41, the check valve being of a double-reed type.

43. The system of claim 41, the check valve being of a ball valve type.

44. A package for holding a quantity of a viscous liquid, comprising:
a supply reservoir holding in the supply reservoir a portion of the quantity of liquid; and
an extension hose having an adapter end adapted to connect to a pump mechanism remote from the supply reservoir, and having an uptake end disposed in contact with the portion of the quantity of liquid, the extension hose holding a remainder of the quantity of liquid outside the supply reservoir.

45. The package for holding liquid of claim 44, wherein the extension hose further comprises:
a threaded end constructed and arranged to screw into the pump mechanism.

46. The package for holding liquid of claim 44, wherein the adapter and further comprises:
a length of flexible tube extending through the pump mechanism.

47. The package for holding liquid soap of claim 44, wherein the extension hose further comprises:
a flared end constructed and arranged to hermetically seal to the pump mechanism.

48. The package for holding liquid of claim 47, the extension hose further comprising:
a flexible tube.

49. The package for holding liquid of claim 48, the flexible tube further comprising:
a polymeric material.

50. The package for holding liquid of claim 49, wherein the polymeric material is a copolymer.

51. The package for holding liquid of claim 49, the plastic material further comprising: Tygon™ material.

52. The package for holding liquid of claim 48, the flexible tube further comprising:
an elastomeric material.

53. The package for holding liquid of claim 44, further comprising:
a cap having two holes defined therethrough; and
a removable seal between the cap and the supply reservoir.

54. The package for holding liquid of claim 53, the removable seal further comprising:
a selectively resealable flap aligned with at least one of the two holes define through the cap.

55. The package for holding liquid of claim 44, wherein the supply reservoir has a flexible wall.

56. The package for holding liquid of claim 55, wherein the supply reservoir is substantially devoid of air.

57. The package for holding liquid of claim 55, wherein the supply reservoir collapses as liquid is removed therefrom.

58. The package for holding liquid of claim 44, further comprising:
a check valve preventing back flow from the extension hose into the supply reservoir.

59. The package for holding liquid of claim 58, the check valve being of a double-reed type.

60. The package for holding liquid of claim 58, the check valve being of a ball valve type.
